(19) United States
(12) Patent Application Publication
(10) Pub. No.: US 2025/0244280 A1
(43) Pub. Date: Jul. 31, 2025

(54) GRAPHENE MODIFIED 3D BIOSENSORS AND METHOD OF FABRICATION

(71) Applicants: Qiong Nian, Chandler, AZ (US); Yan Dou, Tempe, AZ (US)

(72) Inventors: Qiong Nian, Chandler, AZ (US); Yan Dou, Tempe, AZ (US)

(21) Appl. No.: 19/035,493

(22) Filed: Jan. 23, 2025

Related U.S. Application Data
(60) Provisional application No. 63/625,054, filed on Jan. 25, 2024.

(51) Int. Cl. G01N 27/327; B29C 64/118; B33Y 10/00; B33Y 80/00

(52) U.S. Cl. CPC G01N 27/327; B29C 64/118; B33Y 10/00; B33Y 80/00

(57) ABSTRACT

A biosensor electrode and method of fabricating a biosensor electrode from fused deposition modeling 3D printing. The biosensor electrode includes a first material, a second material, and a third material. The first material includes a polyester or a polyurethane. The second material includes a silver-copper composite and is positioned partially positioned between a first layer of the first material and a second layer of the first material. The third material includes reduced graphene oxide, which is applied to an exposed surface of the second material.

### CROSS-REFERENCE TO RELATED APPLICATIONS

This application claims priority to U.S. Provisional Patent Application No. 63/625,054 filed on Jan. 25, 2024, the entire contents of which are incorporated herein by reference.

### STATEMENT REGARDING FEDERALLY SPONSORED RESEARCH OR DEVELOPMENT

This invention was made with government support under 1826439 awarded by the National Science Foundation. The government has certain rights in the invention.

### TECHNICAL FIELD

The present disclosure relates to electrochemical sensors and biosensors, and more particularly, to methods of fabricating electrochemical sensors and biosensors using 3D printing techniques.

### BACKGROUND

Electrochemical sensors are devices that use electrical signals to detect the presence or concentration of a target analyte. They are widely used in a range of applications, including glucose sensors, environmental monitoring, food safety testing, medical diagnostics, and industrial process control.

The manufacturing methods for electrochemical sensors vary depending on the type of sensor and the materials used. One method is chemical vapor deposition (CVD). CVD-synthesized nanomaterials (e.g., metal oxides or 2D materials) often require pre-patterning a surface with a metallic catalyst to trigger layer deposition. The desired materials always grow within a high temperature (up to 1000° C.), low-pressure vacuum environment injected with precursor gases. Hence, this method has found limitations in its high cost, inadequate scalability, and extreme process requirements.

Alternative methods for producing electrochemical sensors are beginning to emerge, including solution-phase printing (e.g., inkjet printing, screen printing, spray coating), lithography and laser-induced graphene (LIG). In general, solution-phase printing techniques use dispersion solvents and polymer additives in the ink, thus require post-print processing, such as thermal, laser, or photonic annealing, to remove undesired polymer additives and enhance electrical conductivity. But annealing or curing at high temperatures potentially damages the paper substrates or thermally sensitive polymer substrate. Some post-print processing steps may require using hazardous chemicals or generating waste materials. Lithography technology is a method for fabricating electrochemical sensors with micro- and nano-scale structures. However, creating the photomask that defines the pattern to be transferred onto the substrate is complex and time-consuming. Besides, lithography is typically used on flat and planar substrates, which can limit the range of applications for electrochemical sensors. LIG has recently gained widespread attention for its rapid, cost-effective, laser assisted maskless production. It typically results in multi-layered porous graphene structures with high electrochemical activity on flat polyimide substrate or phenolic resins, while the resulting structure may have limited mechanical strength.

Accordingly, an electrochemical sensor and a method of fabricating the electrochemical sensor that is multi-functional and adaptable to various conditions using 3D printing technology would be desirable.

### SUMMARY

The present disclosure utilizes fused deposition modeling (FDM) as it is one of the most used three-dimensional (3D) printing techniques to fabricate a multi-functional and adaptable electrochemical sensor. FDM is based on melting polymeric filaments, then extruding and depositing them onto a substrate to build a 3D structure.

The present disclosure provides a biosensor and a method of fabricating the biosensor. The disclosure describes the ability to control the FDM 3D printing parameters to modulate the morphological and structural characteristics of printed electrochemical devices or sensors. Conductive polymer filaments containing carbon black particles, carbon nanofibers, and graphite microparticles, for example, can be used for the FDM 3D printing of electrochemical sensors and biosensors.

In one embodiment, the present disclosure provides a method of fabricating a biosensor. The method comprises printing a three-dimensional (3D) electrode with a conductive filament, simultaneous with printing the 3D electrode, printing a package supporting the electrode with an insulative filament, and applying a reduced graphene oxide solution to the 3D printed electrode in a vacuum environment.

In another embodiment, the present disclosure provides a biosensor electrode comprising a first material comprising a polyester or a polyurethane, a second material comprising a silver-copper composite, wherein the second material is partially positioned between a first layer of the first material and a second layer of the first material, and a third material comprising reduced graphene oxide, wherein the third material is applied to an exposed surface of the second material.

In some aspects, the polyester of the first material is a polylactic acid, and wherein the polyurethane of the first material is a thermoplastic polyurethane.

In some aspects, the third material comprises 10 μg to 120 μg of reduced graphene oxide.

In a further embodiment, the present disclosure provides a method of fabricating a biosensor electrode. The method comprises printing a three-dimensional (3D) electrode with a conductive filament, simultaneous with printing the 3D electrode, printing a package supporting the electrode with an insulative filament, applying a reduced graphene oxide solution to the 3D printed electrode, and applying a vacuum for drying the 3D printed electrode after application of the reduced graphene oxide solution.

In some aspects, applying the reduced graphene oxide solution is performed by drop casting.

In some aspects, the reduced graphene oxide solution comprises Nafion.

In some aspects, the conductive filament comprises polymer, copper, and silver.

In some aspects, a surface of the 3D printed electrode comprises an elemental mass percentage for carbon of about 56.44%-78.31%, copper of about 17.92%-26.05%, and silver of about 1.19%-3.95%.

In some aspects, the 3D electrode comprises an exposed surface with a surface area of approximately 50 mm².

In some aspects, the biosensor electrode includes a plurality of heads.

In some aspects, the biosensor electrode includes more than 2 heads.

In some aspects, the plurality of heads are coupled together at a junction.

In some aspects, a length between a first head and the junction is equal to the length between a second head and the junction.

In some aspects, the biosensor electrode is flexible.

In some aspects, the biosensor electrode is configured to flex between 0 and 180 degrees.

In some aspects, printing the 3D electrode with the conductive filament includes printing the conductive filament with a kiragami pattern

In some aspects, the insulative filament is flexible.

In yet another embodiment, the present disclosure provides a method of fabricating a biosensor electrode. The method comprises printing a first layer comprising an insulating material from a first filament, printing a second layer on top of the first layer, the second layer comprising a conductive material from a second filament, printing a third layer on partially on top of the second layer, the third layer comprising the insulating material from the first filament, drop casting reduced graphene oxide on top of an exposed portion of the conductive material of the second layer.

In some aspects, the second layer and the third layer are printed concurrently.

In some aspects, the first layer, the second layer, and the third layer have a height of 0.15 mm, a line width of 0.4 mm, and an infill density of 100%.

Other aspects of the disclosure will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a method of fabricating a biosensor according to an embodiment of the present disclosure. (a) Schematic diagram of modeling, printing, and encapsulating electrodes using a dual extruder 3D printer. (b) The encapsulation process of the single electrode from different printed layers. The designed model and photograph of the 3D printed electrodes: (c) single-channel electrode, (d) multi-head electrode, and (e) bendable electrode. (f) A cross-sectional layered structure of a single-channel electrode. (g) Schematic representation of surface-modified electrode.

FIG. 2 illustrates (a) a Scanning Electron microscopy (SEM) image of the electrode surface, and corresponding quantitative Energy-dispersive X-ray spectroscopy (EDS) element mapping of carbon (C), silver (Ag), and copper (Cu). (b) Bode plot, (c) Nyquist plot and equivalent circuit derived from electrochemical impedance spectroscopy in 1X phosphate buffer solution for 3D printed bare surface.

FIG. 3 illustrates (a) SEM images of the 3D printed electrodes without rGO modification. (b) SEM images of the 3D printed electrodes with rGO-modified at mass loading of 20 μg, 40 μg, 80 μg, and 120 μg from left to right, respectively. (top: zoom out images; bottom: zoom in images) (c) SEM images of the cross-section of the 80 μg rGO-modified 3D printed electrodes. (d) Raman spectra of 3D printed electrodes without rGO-modified and with rGO-modified at mass loading of 20 μg, 40 μg, 60 μg, and 120 μg respectively.

FIG. 4 illustrates wide-area 3D measurement system working schematic (a) and 3D models of the 3D printed electrodes without rGO-modified (b) and with rGO-modified at mass loading of 20 μg (c), 40 μg (d), 80 μg (e), and 120 μg (f) respectively.

FIG. 5 illustrates (a) Bode plot, equivalent circuit and (b) Nyquist plot derived from electrochemical impedance spectroscopy in 1X phosphate buffer solution for rGO-modified electrodes.

FIG. 6 illustrates (a) Amperometric sensing of 0.1 M concentration increases (steps) of hydrogen peroxide with rGO-modified sensors at distinct mass loading (10 μg, 20 μg, 30 μg, 40 μg, 80 μg and 120 μg) and (b) corresponding linear regression analysis of the current versus concentration. (c) The stability of the measured current for half month at an applied voltage of 0.1 V with rGO-modified sensors at distinct mass loading (20 μg, 30 μg, 40 μg, 80 μg and 120 μg) and (d) 20 μg rGO-modified sensor at distinct concentration (0.05 mM, 0.1 mM, 0.5 mM and 1 mM) (e) Ferricyanide cyclic voltammogram of the 20 μg rGO-modified electrode and (f) corresponding Randles-Sevcik plots showing linear regression analyses of current versus scan rate. Each CV is acquired with five distinct scan rates—5 mV s⁻¹, 10 mV s⁻¹, 20 mV s⁻¹, 50 mV s⁻¹, and 100 mV s⁻¹.

FIG. 7 illustrates (a) multi-head sensor and (b) Amperometric sensing of 0.1 M concentration increases of hydrogen peroxide with multi-head electrode at three distinct mass loading heads (30 μg, 40 μg and 60 μg) and (c) corresponding linear regression analysis of the current versus concentration. (d) bendable electrode displayed in a flexed position. (e) 2-terminal resistance vs. varying bending angles (i.e., 0°, 45°, 90°, 135° and) 180° for bendable electrode and (f) linear regression analysis of the current versus concentration at corresponding bending angles.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The invention is capable of other embodiments and of being practiced or of being carried out in various ways.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifiers “about” or “approximately” used in connection with a quantity are inclusive of the stated value and have the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example, “about 1” may also mean from 0.5 to 1.4.

For the recitation of numeric ranges herein, each intervening number therebetween with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated.

Definitions of chemical terms are described in more detail below. For purposes of this disclosure, the chemical elements are identified in accordance with the Periodic Table of the Elements, CAS version, Handbook of Chemistry and Physics, 104th Ed., inside cover, and specific functional groups are defined as described therein.

The present disclosure provides a system and method for the 3D printing of sensor electrodes with high sensitivity. For example, the specific surface area of the electrode probe is increased by introducing surface patterns to the sensor probe through 3D printing. A greater surface area enhances the sensor's sensitivity, leading to more pronounced detection signals. This is especially beneficial in applications where minute changes need to be detected.

Additionally, the inherent design flexibility offered by 3D printing means allows for electrochemical sensors to be custom-tailored for specific applications or to incorporate multiple functionalities. The ability to design multifunctional sensors could revolutionize how sensors are integrated into various applications, from medical devices to structural monitoring.

Additional benefits are described below by using drop casting, which is a simple and versatile technique, for depositing a wide range of materials onto a surface. Compared to other methods like inkjet printing, drop casting does not require the addition of certain polymers or additives to the ink. This means that the sensor maintains a higher degree of purity, which might enhance its performance and specificity.

The present disclosure provides a system and method for the 3D printing of sensor electrodes with high sensitivity. The method includes FDM using a filament containing nanosized metals with high electrical conductivity. The process involves printing electrodes with excellent conductivity and then imparting electrochemical activity by modifying the electrode surface. The system includes a dual extruder printer to print both the conductive and encapsulation materials, enabling the integration of electrode encapsulation and batch production. After printing, a coating of reduced graphene oxide (rGO) (using aqueous solution, no additives) is applied onto the surface for electrode modification, which allows the electrode to have excellent electrical conductivity and simultaneously desired electrochemical activity on the surface. Additionally, the specific surface area of the rGO-modified electrode is significantly increased as the rGO flakes are coated on the FDM printing paths and thereby forming a rough surface. This 3D printing morphology feature is further confirmed by microscopic observations. Electrochemical sensing is also displayed by this scalable, 3D structuring of the rGO-modified electrode without any additional post-printing processing steps. Electrodes with different shapes and designs are printed and utilized for hydrogen peroxide (H₂O₂) sensing.

### I. Printed 3D Electrodes

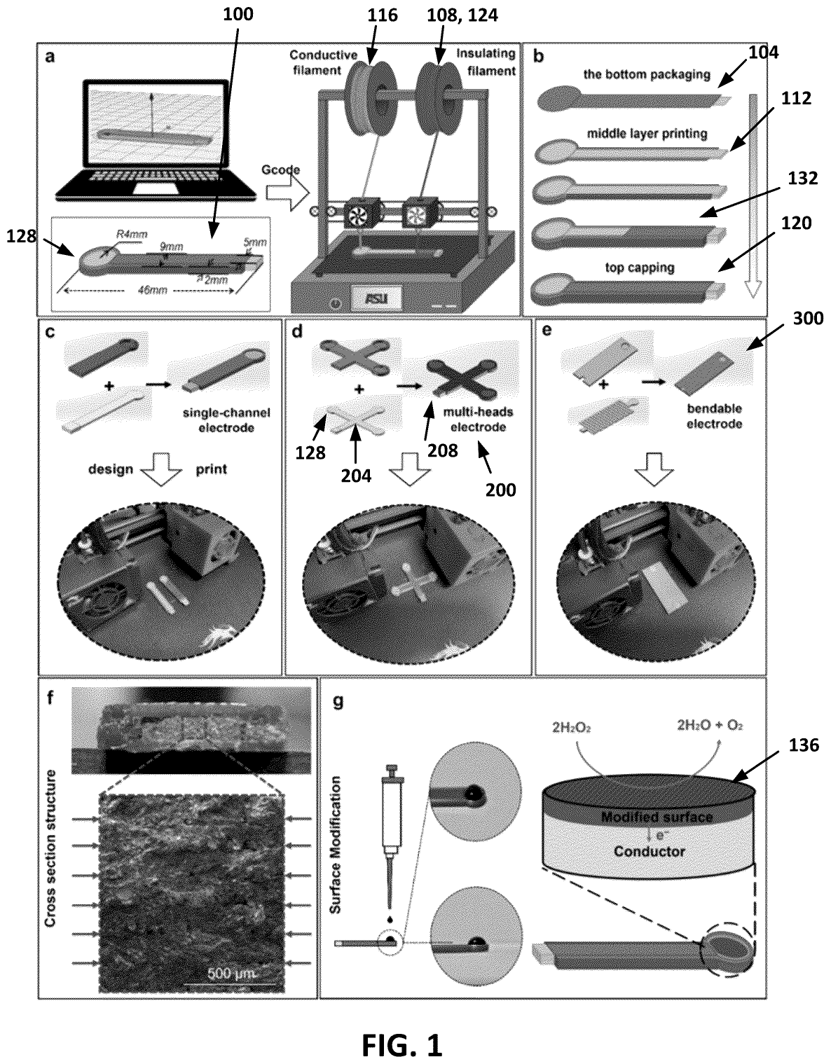

FIG. 1 schematically depicts an exemplary biosensor electrode 100 fabricated by a FDM 3D printing process, as described below, according to some embodiments of the present disclosure. In some embodiments, the biosensor electrode 100 includes a first layer 104 comprising a first material 108 (e.g., an insulative material), a second or middle layer 112 comprising a second material 116 (e.g., a conductive material), and a third layer 120 comprising a third material 124 (e.g., an insulative material). The biosensor electrode 100 also includes a head 128 and a channel 132. As illustrated, the head 128 is circular in shape, however the disclosure is not limited to this shape. In some aspects, the head 128 can be oval or square-shaped, and the like. The head 128 remains exposed and not covered by the third layer 120. The head 128 includes a surface 136 (see FIG. 1 (at g)) that is modified with rGO.

FIG. 1 (at d) schematically depicts an exemplary multi-head biosensor electrode 200 according to some embodiments. In this embodiment, the multi-head biosensor electrode 200 combines a plurality of the biosensor electrode 100. As shown, the plurality of biosensor electrodes 100 connect at a junction 204. As shown, the multi-head biosensor electrode 200 includes three heads 128, however the disclosure is not limited in this regard. In some aspects, the multi-head biosensor electrode 200 can include more than three heads (e.g., 4, 5, 6, 7, or 8, for example) or less than three heads (e.g., 2). The multi-head biosensor electrode 200 also include a secondary channel 208 extending from the junction 204 that is configured to connect to laboratory equipment. In some embodiments, the plurality of channels 132 extending from each head 128 has a length between the head 128 and the junction 204 that is the same. For example, the first channel 132 has a length of 45 mm, a second channel 132 has a length of 45 mm, and a third channel has a length of 45 mm. In other embodiments, the plurality of channels 132 may have varying lengths. For example, a first channel 132 has a length of 45 mm, a second channel 132 has a length of 46 mm, and a third channel has a length of 47 mm.

In this multi-head biosensor embodiment, multiple heads 128 can simultaneously gauge a substance's concentration, enhancing calibration and accuracy. Additionally, applying different enzymes or ion-selective polymers on each electrode head 128 provides multi-substance detection.

FIG. 1 (at e) schematically depicts an exemplary flexible biosensor electrode 300 according to some embodiments. In this embodiment, a unique kirigami structure is utilized, which incorporates a zigzag pattern. This format ensures efficient stress distribution during bending. A flexible thermoplastic polyurethane casing encloses the electrodes.

FIG. 1 (at a) illustrates a method of fabricating biosensors 100, 200 according to some embodiments. A FDM 3D printing process is employed to fabricate rGO-modified electrodes according to some embodiments of the present disclosure. This process provides for an electrochemical sensor manufacturing process. The process utilizes a 3D printer with dual extruder for printing both a conductive filament and an insulating filament. The conductive filament prints the electrode, and the insulating filament prints the external packaging of the electrode.

FIG. 1 (at a) provides a schematic depiction of the operation of a dual extruder, illustrating a simultaneous, single-step co-printing of both conductive (yellow color) and insulating (blue color) filaments, in alignment with the electrode model. Note that the printing parameters of the two extruders (e.g., extruder temperature, infill density, infill pattern, printing speed, etc.) can be independently controlled to optimize the quality of the electrode and external packaging.

FIG. 1 (at b) shows a detailed process of co-printing of the sensor electrode. The co-printing process can be divided into three steps: the bottom packaging, middle layer printing, and top capping. At the beginning of the printing process, several layers of insulated filament are printed as the bottom packaging. These layers should be printed smoothly and should have good adhesiveness with the conductive filament, since they are used as the substrate for printing conductive filaments in intermediate layers. Then, in the process of printing intermediate layers, each layer of conductive material is printed with the surrounding area wrapped by the insulated materials simultaneously to ensure sealing. During the final capping process, several layers of the insulated filament are printed again to expose a defined circular area of conductive material to fabricate the electrode.

Three distinct sensor electrodes were designed with different functions by utilizing the characteristics of the dual extruder printer during the co-printing process. The first sensor electrode design is a single-channel electrode (yellow color) 100 encased in a polylactic acid (PLA) package (blue color), as shown in FIG. 1 (at c). The single-channel electrode, in one example, has a length of 45 mm, width of 5 mm, and thickness of 1 mm, while the package has a thickness of 0.5 mm that not only seals the electrodes but also defines the active area of the sensor. The active surface area is approximately 50 mm² with a radius of 4 mm. The overall geometrical design and sizes are shown in FIG. 1 (at a).

FIG. 1 (at d) illustrates a second electrode design, which is a multi-head sensor electrode 200 that forms a cross shape by adding two more identical electrode heads to the single channel design. Each head has the same channel length of 45 mm to the connection. The purpose of designing three heads is to achieve calibration by sequentially measuring the concentration of the same substance with each head, collecting corresponding data, comparing the data with each other, and processing the data to obtain more accurate results. Additionally, the three-head sensor electrode also has the potential to detect different substances by applying various enzymes or ion selective polymers to each electrode head.

The third electrode design, which is a bendable sensor 300, is shown in FIG. 1 (at c). This biosensor 300 is configured to be bendable like a kirigami structure. The kirigami structure extends 60 mm long and 20 mm wide, and includes a zigzag pattern (yellow color mark) with the chain width of 1.5 mm and thickness of 1 mm. This shape provides effective stress relief during bending. Moreover, the electrodes are enclosed in an outer shell made of flexible thermoplastic polyurethane (TPU, grey color mark), to define the same active area as the first two designs.

The three electrode embodiments described above are then printed using the dual extruder printer and photos are shown in the lower sections of FIG. 1 (at c-e), respectively. Noteworthy, during electrode printing, the choice of printed materials, the printing temperature, and the infill pattern have significant impacts on the final electrode performance. The conductive filament comprises a metal composite, primarily containing silver and copper, intertwined with biodegradable polyester. The measured resistivity of this composite is approximately 0.34 Ω·cm. It is critical that the selected electrode materials maintain substantial conductivity subsequent to the printing process. A lack of sufficient conductivity would compromise the ability of the electrode to propagate electrical signals effectively. The printing process is executed at a minimum printable temperature of 175° C. This temperature is notably higher than the recommended range of 140° C. to 160° C. This increase is necessitated by the narrow heating zone of the 3D printer. Post-printing, the resistivity escalates to 1.65 Ω·cm for the printed electrodes. Regarding the insulating filaments, PLA is chosen for the single-channel and multi-heads electrodes, while TPU is selected for the bendable electrode. These filaments are employed to encapsulate the electrodes at a printing temperature of 210° C. As for the infill pattern, all the electrodes and packaging are printed with a 100% infill density. The lines are patterned in one direction, either along the X- or Y-axis, on alternating layers. This expedited printing pattern not only economizes on material usage but also ensures the maintenance of electrical conductivity. Upon completion of the printing process, the 2-terminal resistance measured from the active area of the electrode to the back contact is roughly 150Ω for both the single-channel and multi-head electrodes. Meanwhile, the bendable electrodes preserve their electrical conductivity, exhibiting approximately 400Ω for 2-terminal resistance, in both flattened and bent states.

FIG. 1 (at f) provides a cross-sectional depiction of the electrode, accurately embodying the distinctive printing characteristics inherent to the sensor electrode. The design specifications have been meticulously adhered to, with the insulating PLA sheath completely enveloping the electrodes (FIG. 1 (at f) top photo), offering a significant level of encapsulation. The Scanning Electron Microscope (SEM) cross-sectional image (FIG. 1 (at f) bottom) of the electrode reveals an intricate layered printing structure. Each distinct layer stands at an approximate height of 150 μm, which is defined by the 3D printing layer thickness. The interlayer connectivity is characterized by a close bonding between layers, a feature that is critical for maintaining the overall conductivity of the electrode.

In addition to the high electrical conductivity, desired electrochemical activity is also of critical importance to pursue the sensor electrode with optimal sensing capabilities. To realize the desired electrochemical activity, a surface modification process was implemented using rGO drop casting as shown in FIG. 1 (at g) after the electrode printing. The rGO is chosen herein as one example though other materials can be used as well, such as currently well explored CNT, MXene nanometals, conductive polymers, enzymes, etc. Another reason to choose rGO is that past research has furnished evidence supporting the significant catalytic impact of graphene-based biosensors on the redox reactions involving hydrogen peroxide, a transducer that plays a pivotal role in biological processes and serves as an essential chemical reagent in numerous industrial applications. As shown in FIG. 1 (at g, right), following the application of the rGO casting, the sensor electrode successfully acquires its sensing capabilities with the graphene surface serving as a catalyst reducing the hydrogen peroxide to water and oxygen. Throughout this transformation, the electrons derived from the reduction process traverse the rGO layers and are subsequently transmuted into electrical signals at the electrode site.

### II. Modification of Bare Electrodes Surfaces

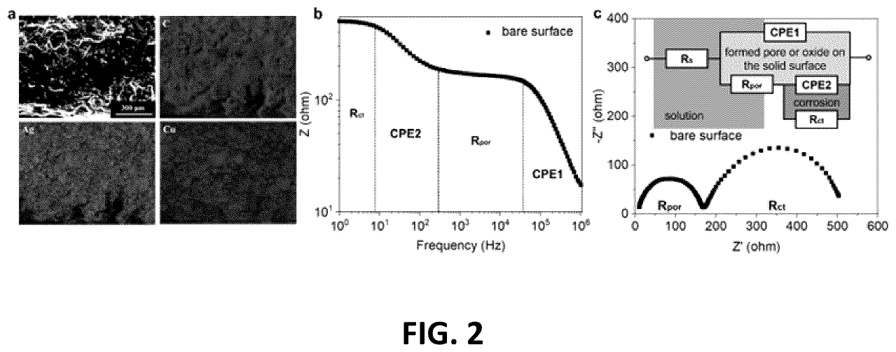

Upon completion of the printing process, the elemental distribution on the bare electrode surface is evaluated using EDS mapping. As depicted in FIG. 2 (at a), the elements carbon (C), copper (Cu), and silver (Ag) are found to be uniformly dispersed across the entire surface. This uniformity is a consequence of the metal-polymer composite nature of the conductive filament, which primarily consists of biodegradable polyester and copper. Quantitative analysis revealed that the elemental mass percentages of carbon, copper, and silver on the electrode surfaces were approximately 56.44%, 26.05%, and 3.95%, respectively. The working range of elemental mass percentages for carbon was approximately 56.44%-78.31%, for copper was approximately 17.92%-26.05%, and for silver was approximately 1.19%-3.95%. These proportions of uniformly distributed and well-connected copper and silver are crucial for ensuring electrode conductivity. Moreover, the substantial quantity of carbon connects copper and silver as bonders in the form of thermoplastic polyester.

The EIS technique is employed subsequently to assess the impedance of the bare electrode surface in 1× phosphate buffered saline (PBS). A Bode plot for the electrode is generated (FIG. 2 (at b)), in which the logarithm of the impedance's absolute value (Z) is plotted against the logarithm of frequency (f). These data presentations give direct information about frequency and Z and determine the different constituent phases of the system. In those frequency regions where a horizontal line characterizes the log Z-log f representation, resistive behavior dominates. Additionally, a slope in the log Z-log f plot signifies capacitive behavior within certain frequency areas. Compared to Bode plot, the Nyquist plot of bare electrode surface (FIG. 2 (at c)) presents impedance data in a different format, which revealing two semi-circles in the high-frequency and mid-frequency regions. The first semi-circle (high frequency) corresponds to the passive surface (Rp), while the second semi-circle (mid-frequency) represents charge-transfer resistance (Rct). The radiuses of these semi-circles provide the values of the Rp and Rct, offering insights into the electron-transfer kinetics at the electrode interface. Consequently, an equivalent electrical circuits model for the bare electrode surface is proposed (FIG. 2 (at c)). This model, based on the EDS analysis and impedance curves, aims to provide a logical and consistent physical interpretation of the phenomenon.

The proposed equivalent electrical circuit model for bare electrode surface comprises of the electrolyte solution (PBS) resistance Rs, a constant phase element CPE1 with an impedance (Z_{CPE1}) which probably causes by the capacitance of the formed oxide products and pores on the solid surface of copper-polyester. The Rp within a formed pores or oxides on the solid surface might be associated with the degradation of polyester and the corrosion of copper. The Rct characterizes the polarization of the copper-polyester due to the formation of the electric double layer on the interface between the copper-polyester and the PBS solution. A constant phase element CPE2 with impedance Z_{CPE2} which represent the capacitance of electrical double layer (C_{dl}) on the interface between the copper-polyester and the PBS solution. From a physical interpretation standpoint, the current traverses the copper-polyester surface through ionic charge transfer. This process results in either charge transfer across the interface (leading to corrosion and degradation) or charge storage at the interface, forming pores and oxides on the surface. These can be regarded as a passivation film. The emergence of this passivated impedance hampers charge transfer and reduces the electrical conductivity of the surface. If the negative effects of this passivation film can be mitigated, the electroactive surface area could be expanded, thereby enhancing electron transport between the medium and the electrode.

In addressing the issue precipitated by the unstable electrochemical properties of the metal elements on the electrode surface, the surface was coated with rGO in order to enhance its electrocatalytic characteristics. This casting approach is considerably simpler and more effective than alternative surface processing methods. rGO suspensions are straightforward to prepare and, given their exceptional performance, have been the subject of considerable research in the field of graphene-based sensors. The rGO suspension drop coating process is conducted in open air while the drying process after coating is conducted in a vacuum, thus efficiently preventing the metal elements on the electrode surface from reacting with oxygen and carbon dioxide in moist air.

### III. Microstructure Determination Through Scanning Electron Microscopy

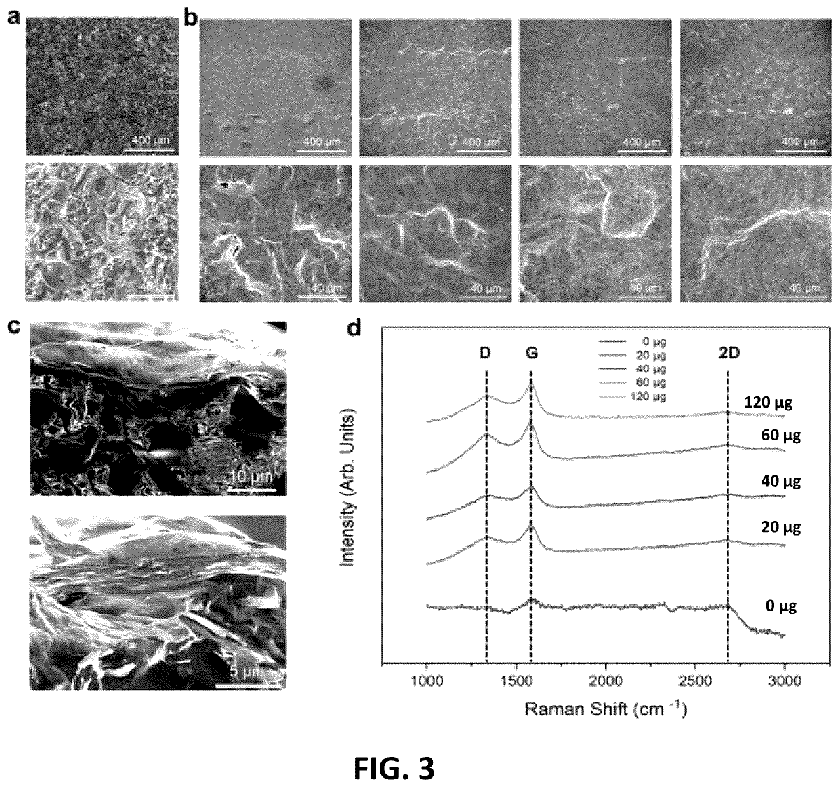

To understand the microstructural transformation from the surface of printed electrodes to the rGO-modified surface, an initial analysis of the printed electrode surface morphology was conducted using SEM (FIG. 3 (at a)). The electrode surface exhibits overlapping line-by-line features on a 400 μm scale. These features are a direct result of the line infill 3D printing process, which prints lines in one direction on alternate layers. The width of each line is approximately 485 μm, and each line exhibits a rough and scoriaceous surface texture. The SEM image, at a 40 μm scale, provides a clearer view of these features, revealing their relative roughness and microholes. Hence, it can be inferred that 3D printing contributes a degree of roughness to the electrode surface.

Furthermore, the morphology of the rGO drop coated electrode surfaces was investigated using SEM at different mass loadings, and a significant correlation with the 3D-printed electrode surfaces is observed (FIG. 3 (at b)). The SEM images revealed that the microstructure of the rGO-modified electrode surfaces consisted of continuous sheets of rGO covering the numerous micro holes. The presence of the rough printed lines led to various topological imperfections on the rGO sheets, such as wrinkles and ridges. These imperfections were clearly visible in the SEM images at a 400 μm scale for the 20 μg and 40 μg rGO coatings. Additionally, when examining the SEM images at a 40 μm scale, it was observed that the lower mass rGO-modified electrode surface exhibited a higher density of wrinkles and ridges. However, as the mass of the rGO increased to 80 μg and 120 μg, the imperfections caused by the rough printed lines became less distinguishable. This indicated that the surface microstructure of the rGO-modified electrode surfaces gradually becomes smoother, with a decrease in the density of imperfections as the mass of rGO increases.

An exemplary biosensor electrode may comprise a third material comprising an amount of reduced graphene oxide per 50 mm² of bare electrode surface area that may be between 10 μg and 120 μg. In various instances the amount of reduced graphene oxide per 50 mm² of bare electrode surface area is between 10 μg and 120 μg; 15 μg and 120 μg; 20 μg and 120 μg; 25 μg and 120 μg; 30 μg and 120 μg; 35 μg and 120 μg; 40 μg and 120 μg; 45 μg and 120 μg; 50 μg and 120 μg; 55 μg and 120 μg; 60 μg and 120 μg; 65 μg and 120 μg; 70 μg and 120 μg; 75 μg and 120 μg; 80 μg and 120 μg; 85 μg and 120 μg; 90 μg and 120 μg; 95 μg and 120 μg; 100 μg and 120 μg; 105 μg and 120 μg; 110 μg and 120 μg; 115 μg and 120 μg; 10 μg and 115 μg; 10 μg and 110 μg; 10 μg and 105 μg; 10 μg and 100 μg; 10 μg and 95 μg; 10 μg and 90 μg; 10 μg and 85 μg; 10 μg and 80 μg; 10 μg and 75 μg; 10 μg and 70 μg; 10 μg and 65 μg; 10 μg and 60 μg; 10 μg and 55 μg; 10 μg and 50 μg; 10 μg and 45 μg; 10 μg and 40 μg; 10 μg and 35 μg; 10 μg and 30 μg; 10 μg and 25 μg; 10 μg and 20 μg; or 10 μg and 15 μg. In various instances the amount of reduced graphene oxide per 50 mm² of bare electrode surface area is no less than 10μ; 15μ; 20μ; 25μ; 30μ; 35μ; 40μ; 45μ; 50μ; 55μ; 60μ g; 65 μg; 70 μg; 75 μg; 80 μg; 85 μg; 90 μg; 95 μg; 100 μg; 105 μg; 110 μg; 115 μg; or 120 μg. In various instances the amount of reduced graphene oxide per 50 mm² of bare electrode surface area is no more than 120 μg; 115 μg; 110 μg; 105 μg; 100 μg; 95 μg; 90 μg; 85 μg; 80 μg; 75 μg; 70 μg; 65 μg; 60 μg; 55 μg; 50 μg; 45 μg; 40 μg; 35 μg; 30 μg; 25 μg; 20 μg; 15 μg; or 10 μg.

Additionally, the morphology of the rGO-modified electrodes can be better visualized by examining their cross-section (FIG. 3 (at c)). The layers of rGO sheets envelop the undulating printed substrate, thereby increasing the specific surface area of the rGO-modified electrode surface. Furthermore, from the fracture of the rGO, it was observed that the thickness of the 80 μg rGO sheets is approximately 2 μm. This indicates that the graphene layers already possess a certain thickness.

### IV. Roughness Inspection of Sensor Electrode Surfaces

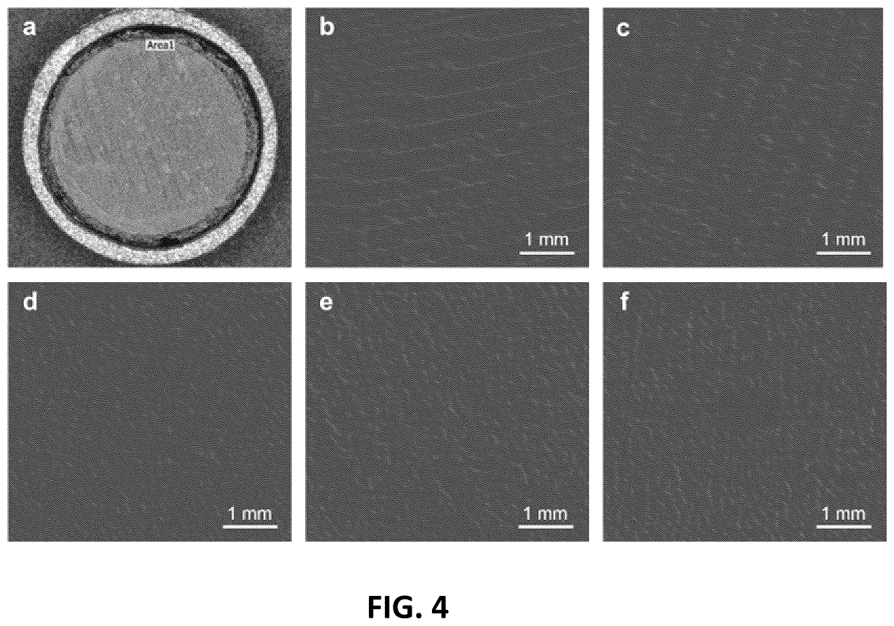

To understand the variations in the roughness of bare electrode surface and rGO-modified electrode surface, a wide-area, non-contact, and high-resolution 3D measurement system was employed. Equipped with a camera mounted directly above the sample, it captures the distortions in light bands due to alterations in the surface height of the sample, as shown in FIG. 4 (at a). These measured distortions were triangulated among varying patterns to construct a quantitative 3D model of surface topography. The captured images revealed that the electrode surface modified with 20 μg rGO (FIG. 4 (at c)), still retains a discernible pattern of printed lines, similar to the bare electrode surface (FIG. 4 (at b)). On the contrary, the trace left by the 3D printing process is absent on the surfaces of the electrodes modified with 40 μg, 80 μg, and 120 μg rGO (FIG. 4 (at d, e, and f)). Notably, the electrodes modified with 40 μg or more rGO display similarly uneven surfaces.

Table 1 presents the arithmetical mean height (Sₐ) and maximum height (S_{z}) of the electrode surfaces, as gathered from the wide-area 3D measurement system. The bare electrode demonstrates a Sₐ of 0.025 mm and an S_{z} of 0.407 mm. However, upon the application of rGO coating, there is an increase in the Sₐ and S_{z} values to 0.033 mm and 0.962 mm respectively at 20 μg, followed by a gradual decline to 0.012 mm and 0.101 mm at 120 μg. The observed increase in Sₐ and S_{z} values when transitioning from the uncoated state to the 20 μg rGO coated state implies effective dispersion of the 20 μg rGO flakes on the rough electrode surface. Not only does the right amount of rGO coating maintain the surface roughness of the electrode, but it also contributes to a minor increase in the overall surface roughness. Subsequently, the declining Sₐ and S_{z} values on the rGO coated surface, as the coating increases from 20 μg to 120 μg, indicate that an increasing number of graphene sheets are stacking atop each other, leading to a gradual flattening of the electrode surface. These observations are congruent with the conclusions derived from the SEM results, further strengthening the understanding of the correlation between rGO coating quantity and surface roughness of the electrode surface.

TABLE 1
The arithmetical mean height and a maximum height of 3D
printed electrode surface and rGO-modified surfaces.

| | bare | 20 μg rGO | 40 μg rGO | 80 μg rGO | 120 μg rGO |
|---|---|---|---|---|---|
| | surface | modified | modified | modified | modified |
| Sₐ (mm) | 0.025 | 0.033 | 0.029 | 0.024 | 0.012 |
| S_{z} (mm) | 0.407 | 0.962 | 0.259 | 0.181 | 0.101 |

### V. Microstructure Determination by Raman Spectroscopy

Subsequent to the observations, Raman spectroscopy is employed to characterize the microstructure of the rGO coating (FIG. 3 (at d)). Contrary to the electrode bare surface, which did not exhibit any characteristic peaks, the Raman spectra of the rGO-modified surfaces revealed D, G, and 2D peaks. These peaks, manifesting in distinct ranges, provide valuable information regarding the structure of graphene. Specifically, the D peak (˜1336 cm⁻¹) signifies the disordered vibrational peak of graphene; the G peak (˜1585 cm⁻¹) is indicative of the in-plane vibration of carbon atoms; and the 2D peak (˜2690 cm⁻¹) represents a two-phonon resonance Raman peak.

It is noteworthy that the 2D peak is particularly sensitive to the stacking of graphene layers. Consequently, it can be utilized to ascertain the number of graphene layers (be it monolayer, double layer, or multilayer). Given that the 2D peak of monolayer graphene characteristically emerges at 2679 cm⁻¹ and presents a well-defined single Lorentzian peak pattern, the observed shift in position of the 2D peak combined with the full width at half maximum (FWHM) analysis infer that the rGO coating on the electrode comprises multiple layers. Furthermore, the shift in the 2D peak position can be attributed to residual oxygen-containing functional groups remaining post the reduction of graphene oxide (GO) to rGO. All the ID/IG ratio for rGO, as derived from the Raman spectra, approximates 1.04. This indicates the presence of disordered edge states in all rGO-modified surfaces. Such disorder facilitates a larger contact area with the electrolyte and exposes a greater number of electrochemical reaction active sites.

VI. Electrochemical Impedance Spectroscopy of rGO-Modified Sensor Electrodes

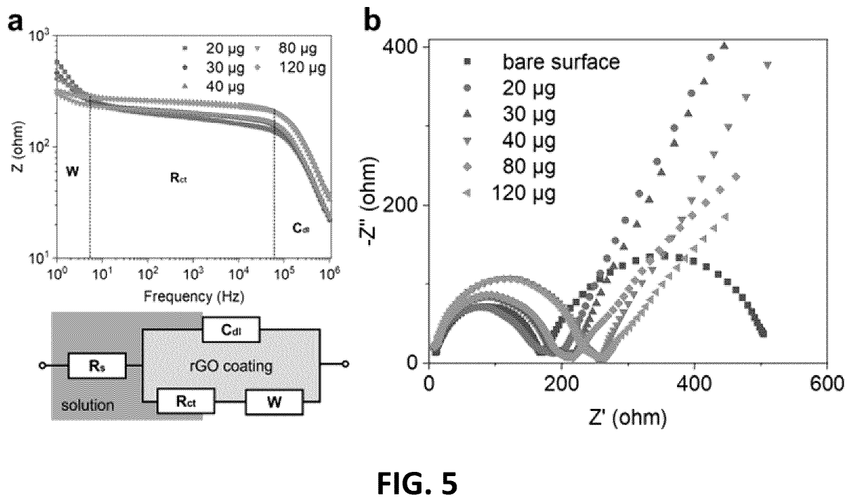

To probe into the variations in interfacial properties, the EIS technique is utilized to measure the impendence of rGO-modified surfaces across a range of frequencies in PBS. The Bode plot (FIG. 5 (at a, top)) offer direct information about frequency and Z and assists in determining the different constituent phases of the system, which contributes to the construction of an equivalent circuit of the rGO-modified surface in PBS. This modelled circuit comprises four main components (FIG. 5 (at a, bottom)): The Rs represents the ionic conduction, R_{ct} and C_{dl} symbolize the charge transfer at the rGO surface and the charging-discharging processes at double layers, respectively. The Warburg Impedance (W), a common circuit element employed for modeling diffusion behavior, illustrates the mass transport process in this context. Insights into the charge transfer dynamics and diffusion behavior in the rGO-modified surfaces can be obtained from the Nyquist plots (FIG. 5 (at b)). The presence of semicircles in the high-frequency domain corresponds R_{ct}, while the slope of the straight lines in the low-frequency region bears a linear relation to the ion diffusion coefficient. Interestingly, the rGO coating appears to eliminate the passivated film impedance of the electrode bare surface. It safeguards the printed surface of the electrode from oxidation and degradation while simultaneously facilitating ion diffusion from the electrolyte to the sensor surface. Moreover, the diameter of the semicircle yields the R_{ct} value. The R_{ct} for all electrodes is approximately a mere 200 ohms. This value is significantly smaller than those reported in previous studies concerning graphene-based sensor.

### VII. Electrochemical Detection of Hydrogen Peroxide

rGO exhibits excellent performance as a catalyst for H₂O₂ due to the presence of residual oxygen-containing groups. The hydroxyl, carbonyl, and carboxyl groups located at the edges of rGO are highly reactive and promote the breakdown of H₂O₂ into hydroxyl radicals. Additionally, the oxygen-containing groups on the basal plane of rGO, including hydroxyl and epoxide groups, facilitate the cleavage of H₂O₂ into O and H₂O molecules. This dual functionality establishes the fundamental basis for rGO to be utilized as a hydrogen peroxide sensor.

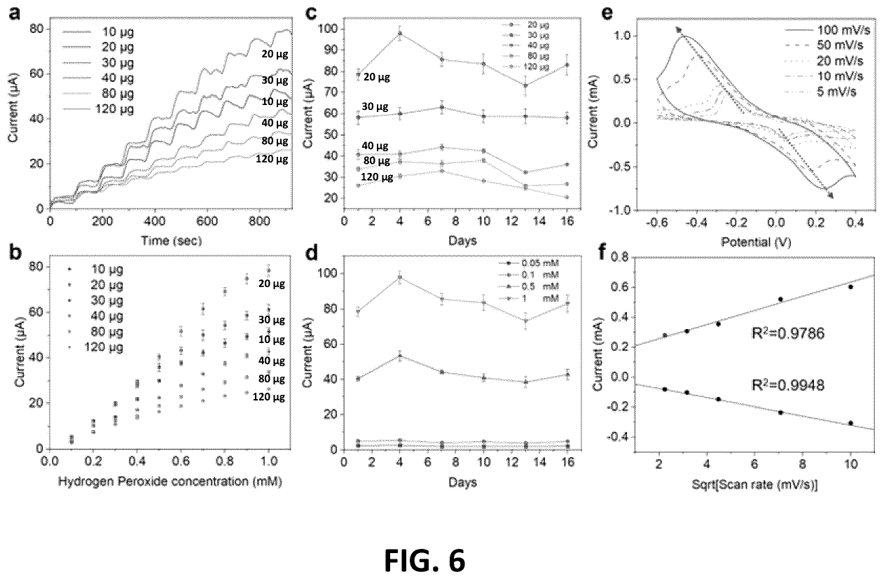

Thus, an investigation into the relationship between sensitivity and the mass gradient of rGO in the single-channel sensor electrode is presented in FIG. 6 (at a and b). The sensitivity is found to be highest for the sensor electrode coated with 20 μg of rGO. Beyond this point, an incremental increase in the coating mass results in a gradual decrease in sensitivity. Notably, the sensitivity of H₂O₂ oxidation at 120 μg is approximately one-third of that observed at 20 μg, dropping from 156 mA·M⁻¹·cm⁻² to 52 mA·M⁻¹·cm⁻². When considering the 10 μg sensor electrode, its sensitivity is inferior to that of the 20 μg sensor electrode, due to the insufficiency of rGO mass to fully cover the electrode surface. The plot representing the current versus H₂O₂ concentration across all mass gradients, from 10 μg to 120 μg, demonstrates a linear relationship within the range of 0.1 to 1 mM, and boasts a high correlation coefficient (R²=0.9824, 0.9876, 0.9932, 0.9972, 0.9956, and 0.9862).

Table 2 provides a comparative view of the manufacturing process and performance of the present sensor electrode with other reported graphene-based sensors. Interestingly, the 3D printed electrode with rGO modification exhibits improved sensitivity relative to other graphene-based sensors with fewer voltage applied. This distinction is primarily due to the rGO suspension not requiring the integration of any non-conductive chemical components to enhance viscosity, as necessitated by technologies such as inkjet printing. Consequently, the charge transfer resistance of the rGO-modified electrode surface is diminished. Moreover, this approach contrasts with traditional methods that employ ink or lasers to create the entire 2D structure of the electrodes. In this methodology, the 3D structure of the electrodes is printed from a highly conductive filament, which substantially mitigates the electron transfer resistance within the electrodes. In summary, compared to conventional forms, the rGO-modified 3D printed electrode is more conducive to receiving and transmitting electrical signals, thereby enhancing overall performance. For instance, when compared to the work of the rGO drop casting sensors, the 3D printed sensor displays five times the sensitivity with a similar rGO ink.

TABLE 2
The sensitivities of graphene-based electrodes with different fabrication and modification methods.

| Electrode | | Electrode | | | |
|---|---|---|---|---|---|
| Fabrication Method | Ink | Modification | potential | Sensitivity | |
| Inkjet printing | GP-PEDOT:PSS | SPCEs | 0.9 v (vs Ag/AgCl) | 1.8 | μA/mM |
| | rGO in | UV-pulsed laser | 0.5 v (vs Ag/AgCl) | 3.99 | μA/mM |
| | terpineol/cyclohexanone | irradiation | | | |
| Screen printing | FeTSPc-GR-Nafion | hydrothermal | 0.35 v (vs Ag/AgCl) | 36.93 ± 0.05 | μA/mM cm² |
| | N-GrNRs | method | 0.4 v (vs Ag/AgCl) | 154.78 | μA/mM cm² |
| LIG | bare-LIG | magnetron | 0.75 v (vs Ag/AgCl) | 6.25 | μA/mM |
| | MWCNT-LIG | sputtering | 0.75 v (vs Ag/AgCl) | 8.63 | μA/mM |
| | PtLIG | process | 0.2 v (vs gold fold) | 248 | μA/mM cm² |
| drop casting | rGO (modified Hummers' | | 0.3 v (vs Ag/AgCl) | 25 | μA/mM cm² |
| | method) | | | | |
| 3D printing&drop | rGO (modified Hummers' | | 0.1 v (vs Ag/AgCl) | 156 | μA/mM cm² |
| casting | method) | | | | |

VIII. Stability and Cyclic Voltammetry of 20 μg rGO-Modified Sensor Electrode

Furthermore, the long-term stability of the rGO-modified sensor electrodes is assessed at specific H₂O₂ concentrations, as depicted in FIG. 6 (at c). The findings reveal the stable operation of these sensor electrodes over a two-week span. By computing the rates of change for different mass gradient sensor electrodes ranging from 20 μg to 120 μg, the values are found to be 10.36%, 5.28%, 17.67%, 21.01%, and 23.17%, respectively. It can be generally observed that electrodes modified with higher masses of rGO demonstrate more pronounced fluctuations as the number of days increase, in contrast to electrodes modified with lower rGO masses. Nonetheless, all sensor electrodes exhibit relatively commendable stability. Further investigations into the stability of the 20 μg sensor electrode at varying concentrations over an increasing number of days (FIG. 6 (at d)) lead to the conclusion that the 20 μg sensor electrode exhibits similar degrees of stable fluctuations across all concentrations.

The electroactive nature of the 20 μg rGO sensor electrode is characterized by evaluating the ferricyanide cyclic voltammetry in response to varying scan rates on the potential and peak current (FIG. 6 (at e and f)). It is observed that as the scan rate increased, the oxidation and reduction peaks shifted towards higher and lower potential, respectively. Concurrently, the variation in peak-to-peak separation (ΔEₚ) from 0.3V to 0.7V indicates a quasi-reversible behavior for the 20 μg rGO-modified sensor electrode. The Randles-Sevcik plots demonstrate a linear relationship between the anodic and cathodic peak currents and the square root of the scan rate (Iₚ˜v^{1/2}), with correlation coefficients (R²) of 0.98 and 0.99 respectively. This insinuates that the reaction occurring at the rGO interface is predominantly diffusion-controlled. In other words, the rate of the reaction is determined by the speed at which the reactants can move or diffuse towards rGO interface.

IX. Electrochemical Detection of H₂O₂ Oxidation by Multi-Head and Bendable Sensors

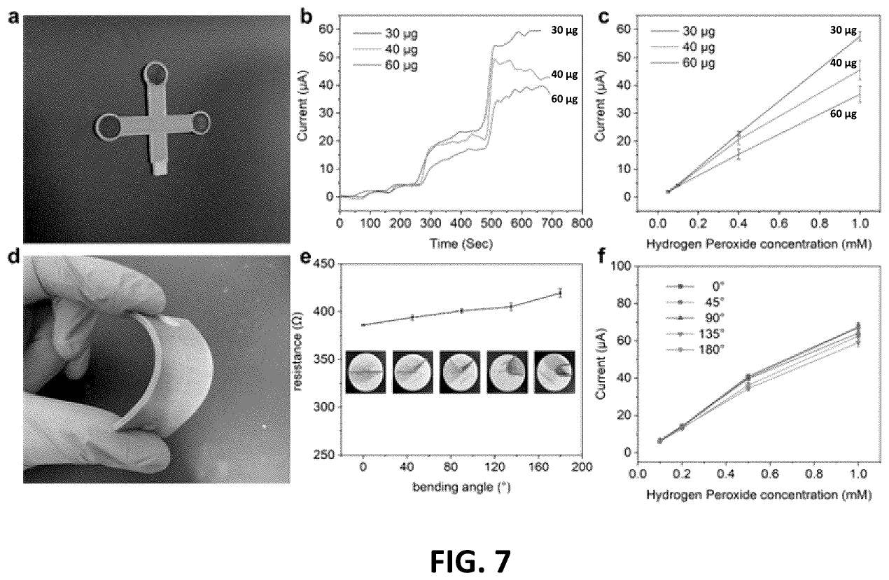

In addition to examining the electrochemical properties of single-channel electrodes, this study also assesses H₂O₂ sensing capabilities on multi-head (FIG. 7 (at a)) and bendable electrodes (FIG. 7 (at d)). FIG. 7 (at b and c) displays the sensitivity of a multi-head sensors with three different masses of rGO loading (60 μg, 40 μg, 30 μg) to H₂O₂. The sensitivities derived from these three varied rGO masses are 73.64 mA·M⁻¹·cm⁻², 90.92 mA·M⁻¹·cm⁻² and 116.87 mA·M⁻¹·cm⁻², respectively. These results align closely with the sensitivities obtained from the single-channel sensors with corresponding rGO loadings, thereby demonstrating the viability of printed multi-channel sensors. Consequently, this indicates that the multi-channel sensor possesses the capability to perform multi-channel corrections for the concentration of a singular solution. Furthermore, the innovative design of the multi-channel electrodes, enabled by 3D printing, allows for not only different masses of rGO to be coated but also different materials, thereby enabling the selection of various electrodes depending on the actual requirements of specific applications.

The flexibility of the bendable electrodes and their ability to maintain proper function is investigated through bending tests. As shown in FIG. 7 (at e), the 2-terminal resistance of a 60 mm uncoated bendable electrode changes as the bending angle is varied from 0° to 180°. The test results indicate that as the bending angle increases, the 2-terminal resistance of the bendable electrode rises from 386Ω to 419.5Ω, fluctuating around the 400Ω mark. This suggests that despite the mechanical bending stress applied to the electrode, it maintains a relatively stable resistance, thus demonstrating the resilience and robustness of the design of the electrode. Specifically, kirigami structure can effectively distribute stress concentration and decrease the chance of cracking and delamination of the inner core during the bending process. Amperometric sensing of H₂O₂ oxidation is also performed on a bendable sensor (30 μg) at different bending angles (FIG. 7 (at f)). With increasing bending angle, there is a slight reduction in sensitivity. When the bending angle is 0°, the sensitivity is at its highest, reaching 134.88 mA·M⁻¹·cm⁻², and at a bending angle of 135°, the sensitivity reaches a minimum of 117.94 mA·M⁻¹·cm⁻². Despite this, the overall change is minimal, with a reduction rate of 12.56%, demonstrating the reliability of the sensor at different angles. The stable mechanical properties further highlight its potential for application in varying mechanical situations.

### EXAMPLES

### I. Materials

A commercial conductive filament (electrifi, Multi3D. Inc) in diameter of 1.75 mm was purchased to print the sensor electrodes. The supplier reported the resistivity of the filament as 0.006 Ω·cm. To print the insulating packaging for the electrodes, a blue color PLA filament and a grey color TPU filament, both in diameter of 1.75 mm, were purchased from Amazon Basics and Creality 3D Inc., respectively. The 3D printer utilized to print the above filaments was Creality Ender-3 pro (Creality 3D. Inc). The printer was upgraded from a single extruder to a dual extruder (Ender IDEX) using the extra parts supplied by SEN 3D. Inc for simultaneous printing and packaging of electrodes. Both nozzles of the dual extruder were in a diameter of 0.4 mm.

For surface modification of the 3D printed electrodes, reduced graphene oxide was prepared from a commercially available 4 mg·ml⁻¹ graphene oxide water dispersion supplied by Graphenea. The GO suspension was diluted to 10 ml with a concentration of 0.25 mg·ml⁻¹. After ultrasonication within 10 min, the diluted dispersion turned dark brown, then added 100 μl of ammonia hydroxide (10% v/v aq. Soln., Alfa Aesar) and 2 μl of hydrazine monohydrate (99+%, Alfa Aesar) into the obtained brown dispersion and shook it vigorously for a few minutes. The dispersion was sealed and put into a 95° C. water bath for 1 h. During the water bath, the dark brown dispersion turned black. Afterward, the resulting black dispersion was cooled down and a precipitation layer floating on the surface of the dispersion was removed to obtain rGO aqueous solution. In addition, 0.5 ml of Nafion (5 wt. % in water, Aldrich) is added into the rGO aqueous solution.

II. Fabrication of rGO-Modified Sensors

Using Computer-aided design (CAD) software SOLIDWORKS, the full-size models of the electrodes with external packaging were created and saved as single stereolithography (STL) files. Then, the STL models were sliced into multiple layers to generate G-code files by using the slicing software Ultimaker Cura. After that, the G-code files were input into the 3D printer with a dual extruder to command the printing of the electrodes with external packaging. The electrodes were printed using the conductive filament at an extrusion temperature of 175° C. The external packaging was printed using the blue PLA and grey TPU filaments at an extrusion temperature of 210° C. All filaments were printed with a layer height of 0.15 mm, line width of 0.4 mm, and infill density of 100%.

After printing, the surfaces of electrodes were modified with the rGO aqueous solution at a series of rGO mass loading: e.g., 10 μg, 20 μg, 30 μg, 40 μg, 80 μg, and 120 μg. Specifically, a quantitative amount of rGO aqueous solution was aspirated by using a pipette gun and dropped onto the active surface of the electrodes. Under the action of surface tension, a water droplet was formed and adsorbed on the active surface of electrodes. Then, the drop coated sensor electrodes were put into a vacuum chamber and dried. After vacuum drying, a series of rGO-modified sensors with different mass loading were received.

III. Scanning Electron Microscopy of rGO-Modified Electrodes

The microstructures of electrode surfaces with and without rGO modification were investigated using a Field Emission Scanning Microscope (FEI Nova 200 NanoLab, Thermo Fischer. Inc). The FE-SEM images were taken in secondary electron (SE) mode using 5 kV accelerating voltage and 1.6 nA beam current with a sample working distance of 5 mm from the field emitter source aperture. In addition, an (EDS) detector was used to determine the chemical compositions and distribution.

IV. Raman Spectroscopy of rGO-Modified Electrodes and Roughness Measurements

Confocal Raman microscope micrographs were obtained with an Acton 300 LN2 spectrometer and the signal was discriminated from the laser excitation using an Ondax SureBlock™ ultranarrow-band notch filter combined with two optigrate notch filters. The samples were detected using a 150 mW Coherent Sapphire SF laser with a 532 nm laser wavelength. For surface roughness testing, the bare electrode surface and rGO-modified surface were measured by Wide-Area 3D measurement VR-3200 (Keyence corporation).

V. Electrochemical Testing and H₂O₂ Sensing

Cyclic voltammetry test and amperometric H₂O₂ sensing were performed from a 3-electrode setup electrically connected to a CHI instrument potentiostat (660 series). The rGO-modified sensor acted as the working electrode, Ag/AgCl (1 M KCl) worked as the reference electrode, and a platinum wire worked as the counter electrode. For CV tests, the electrolyte of 5 mM K₃[Fe(CN)₆] and 0.1 M KCl is used to test the electrochemical activity. The rGO sensor was tested with the following five different CV scan rates: 5 mV/s, 10 mV/s, 20 mV/s, 50 mV/s, 100 mV/s. For H₂O₂ sensing, all electrodes were submerged in a test vial of 10 ml of PBS, and the solution was continuously stirred (600 rpm) with a 0.5 cm (length) magnetic stir bar. Incremental increases in hydrogen peroxide concentration were achieved by pipetting 10 μL of H₂O₂ in the test bottle ten times from 100 mM H₂O₂ solution. A working potential of 0.1 V between the working and counter electrodes was maintained during experiments. In addition, electrochemical impedance spectroscopy was performed at the open-circuit voltage from 1 MHZ to 1 Hz at a bias voltage of 5 mV in 1× phosphate buffer solution.

What is claimed is:

1. A biosensor electrode comprising:
a first material comprising a polyester or a polyurethane;
a second material comprising a silver-copper composite, wherein the second material is partially positioned between a first layer of the first material and a second layer of the first material; and
a third material comprising reduced graphene oxide, wherein the third material is applied to an exposed surface of the second material.

2. The biosensor electrode according to claim 1, wherein the polyester of the first material is a polylactic acid, and wherein the polyurethane of the first material is a thermoplastic polyurethane.

3. The biosensor electrode according to claim 1, wherein the third material comprises 10 μg to 120 μg of reduced graphene oxide.

4. A method of fabricating a biosensor electrode, the method comprising:
printing a three-dimensional (3D) electrode with a conductive filament;
simultaneous with printing the 3D electrode, printing a package supporting the electrode with an insulative filament;
applying a reduced graphene oxide solution to the 3D printed electrode; and
applying a vacuum for drying the 3D printed electrode after application of the reduced graphene oxide solution.

5. The method of claim 4, wherein applying the reduced graphene oxide solution is performed by drop casting.

6. The method of claim 4, wherein the reduced graphene oxide solution comprises Nafion.

7. The method of claim 4, wherein the conductive filament comprises polymer, copper, and silver.

8. The method of claim 7, wherein a surface of the 3D printed electrode comprises an elemental mass percentage for carbon of about 56.44%-78.31%, copper of about 17.92%-26.05%, and silver of about 1.19%-3.95%.

9. The method of claim 4, wherein the 3D electrode comprises an exposed surface with a surface area of approximately 50 mm².

10. The method of claim 4, wherein the biosensor electrode includes a plurality of heads.

11. The method of claim 10, wherein the biosensor electrode includes more than 2 heads.

12. The method of claim 10, wherein the plurality of heads are coupled together at a junction.

13. The method of claim 12, wherein a length between a first head and the junction is equal to the length between a second head and the junction.

14. The method of claim 4, wherein the biosensor electrode is flexible.

15. The method of claim 14, wherein the biosensor electrode is configured to flex between 0 and 180 degrees.

16. The method of claim 14 wherein printing the 3D electrode with the conductive filament includes printing the conductive filament with a kiragami pattern.

17. The method of claim 14 wherein the insulative filament is flexible.

18. A method of fabricating a biosensor electrode, the method comprising:
printing a first layer comprising an insulating material from a first filament;
printing a second layer on top of the first layer, the second layer comprising a conductive material from a second filament;
printing a third layer on partially on top of the second layer, the third layer comprising the insulating material from the first filament;
drop casting reduced graphene oxide on top of an exposed portion of the conductive material of the second layer.

19. The method of claim 18 wherein the second layer and the third layer are printed concurrently.

20. The method of claim 18 wherein the first layer, the second layer, and the third layer have a height of 0.15 mm, a line width of 0.4 mm, and an infill density of 100%.
